(19) United States
(12) Patent Application Publication
(10) Pub. No.: US 2024/0126991 A1
(43) Pub. Date: Apr. 18, 2024

(54) AUTOMATED INTERACTION PROCESSING SYSTEMS

(71) Applicant: Verint Americas Inc., Alpharetta, GA (US)

(72) Inventors: Ron Peretz Epstein Koch, Alpharetta, GA (US); Avidor Tenenboim, Alpharetta, GA (US); Dvir Cohen, Netivot (IL); Eran Sela, Kadima (IL)

(21) Appl. No.: 18/046,116

(22) Filed: Oct. 12, 2022

(51) Int. Cl. G06F 40/289; G06F 9/451; G06F 40/58

(52) U.S. Cl. CPC G06F 40/289; G06F 9/452; G06F 40/58; G06F 16/23

(57) ABSTRACT

An automated interaction processing system is deployed to automatically process an interaction transcription or content to generate response data in a manner that does not require intensive human manual effort.

### BACKGROUND

A customer may initiate a communication session (e.g., phone call, chat) with a customer service contact number and interact with (e.g., speak with or communicate via text) an agent or customer service representative. Managers often review content or interaction transcriptions (e.g., transcripts) describing such interactions to evaluate the performance of agents and customer service representatives. A manager may manually review a transcript describing an interaction between a caller and an agent and try to determine whether the agent uses particular terms. In many examples, different agents may convey the same information differently. For example, an agent may say “What is your address?” and another agent may say “Where do you live?” A manager may write rules or permutations of a given sentence or phrase to facilitate these evaluations. For example, a list of correct answers to the evaluation question, “did the agent ask for the customer's address?” can include the following sentences: (i) what is your address?, (ii) where do you live?, and (iii) where are you located?

Many performance evaluation systems and methods are plagued by challenges and limitations resulting from the intensive human manual effort needed to effectively use these systems and methods.

### SUMMARY

The present disclosure describes methods and systems for automatically evaluating the performance of agents and customer service representatives. Additionally, embodiments of the present disclosure describe methods and systems for generating training data that can be used to train automated quality management machine learning models.

Quality evaluation forms may be used to evaluate the performance of agents and customer service representatives. For example, a manager may manually review a transcript describing an interaction event between a caller and an agent and try to determine whether the agent says particular sentences or terms during the interaction event. In many examples, different agents or customer service representatives may convey the same information in different ways. For example, an agent may say “How can I help you” and another agent may say “Do you need help with anything?” In another example, a customer may say “my bill is too high,” and a different customer may say “why do I have to pay so much?”

Some quality evaluation approaches may incorporate rule-based techniques where a user (e.g., a manager) will write different rules containing every permutation of a given sentence to facilitate content (e.g., transcript) evaluation (e.g., by identifying target phrases based on the written rules). In some examples, a rule may include every word in a given sentence or one or more sequences in the form of, for example, <starting word(s)>*<ending word(s)>. An example of a rule for the sentence “how can I help you” may be a starting word, an ending word, and a predetermined number or words therebetween (e.g., “<how>[maximum of two words]<help>.”) Accordingly, a system may search for sentences where the <starting word(s)> and the <ending word(s)> are separated from one another by no more than N words. In another example, if N is 2 and a rule is “<can you>*<your address>”, then the system may consider the sentence “Can you please confirm your address” as a matching rule. However, the system would not recognize the sentence “Would you confirm your address please” as a matching rule thereby decreasing the accuracy of rule-based quality evaluation systems. Additionally, techniques for manually generating rules can be time consuming as there may be hundreds of variations and/or permutations of rules associated with a single sentence.

Accordingly, embodiments of the present disclosure include automated interaction processing systems that are capable of automatically answering questions for automated quality management systems. In some embodiments, the system can automatically answer a question based on a few examples (e.g., three or four sentences) without requiring manual input of hundreds of variations and/or permutations of rules for a given sentence. Embodiments of the present disclosure include evaluating interactions between customers and customer service representatives to determine whether one or more phrases are similar to one or more stored examples or examples provided by a user. Embodiments of the present disclosure include determining, using a similarity determination operation (e.g., cosine similarity operation, Euclidean distance operation, Jaccard similarity operation, Minkowski distance operation, or the like) and based on a measure of similarity between the one or more phrases and the stored/provided examples, whether the one or more phrases is similar (e.g., has the same meaning or intent) as the stored/provided examples.

In accordance with the present disclosure, a computer-implemented method for is provided, where the method includes: receiving content and one or more sample phrases, wherein the content comprises a plurality of phrases; identifying one or more utterances from the content; generating a plurality of first embedding outputs, wherein each embedding output is associated with a phrase that includes at least one of the utterances; identifying a predetermined number of similar phrases to the sample phrases based at least in part on the first embedding outputs; generating a list of windows based at least in part on the predetermined number of similar phrases; generating a plurality of second embedding outputs, wherein each second embedding output is associated with one of the list of windows; generating, using a similarity determination operation, a similarity score for each window with respect to the one or more sample phrases; and generating response data based at least in part on the similarity scores.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary and the following detailed description of illustrative embodiments are better understood when read in conjunction with the appended drawings. For the purpose of illustrating the embodiments, the drawings show example constructions of the embodiments; however, the embodiments are not limited to the specific methods and instrumentalities disclosed. The drawings are described herein.

FIG. 1 illustrates a system that can be used to process content, according to certain embodiments.

FIG. 2A illustrates an example flow diagram of operations performed to process content, according to certain embodiments.

FIG. 2B illustrates an example flow diagram of operations performed to process content, according to certain embodiments.

FIG. 3 illustrates an operational example depicting a relevance determination component, according to certain embodiments.

FIG. 4 illustrates an operational example depicting a deep learning model component, according to certain embodiments.

FIG. 5 illustrates an operational example depicting a localization component, according to certain embodiments.

FIG. 6 illustrates an operational example depicting a deep learning component and a similarity determination component, according to certain embodiments.

FIG. 7 illustrates example computing systems that may be utilized according to certain embodiments.

### DETAILED DESCRIPTION

Overview

The present disclosure is directed to an automated interaction processing system that can automatically process content, including, but not limited to interaction transcriptions and other forms of textual data. The content may describe interaction events (e.g., conversation, dialogue, or the like) between a caller or customer and an agent or customer representative. As an example, an agent or customer representative may be associated with service infrastructure such as, but not limited to, a contact center, a business, a service provider, a government agency, a healthcare provider, a financial services organization, a person or other organization or individual that has a function to interface with its customers. In some embodiments, the agent or customer representative may be a chatbot or conversational artificial intelligence that is configured to independently simulate conversation with human users (e.g., via text or aurally). According to certain embodiments, a customer may be a chatbot or intelligent virtual assistant.

Example Environment and Processes

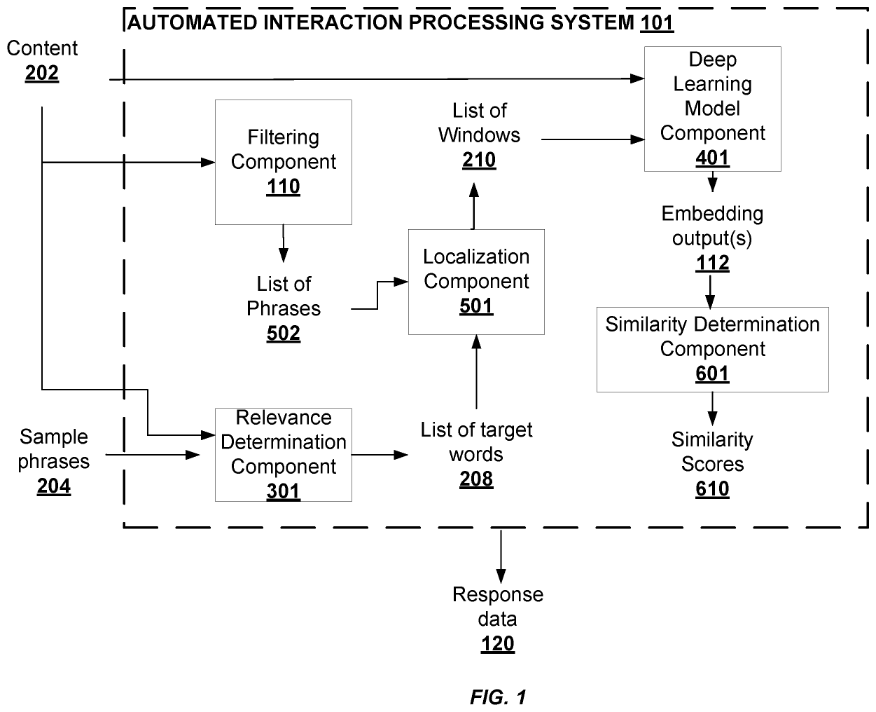

With reference to FIG. 1, the present disclosure includes an automated interaction processing system 101 for processing (e.g., analyzing) content 202 (e.g., interaction transcription, data describing segments or portions of an interaction between two entities). The automated interaction processing system 101 can be configured to process content 202 (e.g., interaction transcriptions) and output response data 120. In some embodiments, response data 120 may be or comprise automatically generated answers to an evaluation form or evaluation question set. For example, if an evaluation question is “Did the agent ask where the customer lives?”, response data 120 associated with the evaluation question may comprise an indication of whether or not the agent asked where the customer lives (e.g., “yes” or “no”).

In various embodiments, the automated interaction processing system 101 can be configured to process content 202 (e.g., interaction transcription, a transcript of an interaction between a caller and a customer service representative) and sample phrases 204 (e.g., a list of manually tagged sentences that may be provided by a user). The sample phrases 204 may be or comprise target phrases or terms that are associated with the correct answer to one or more questions (e.g., from an evaluation form).

As depicted in FIG. 1, the automated interaction processing system 101 can include a filtering component 110, a relevance determination component 301 (e.g., term frequency-inverse document frequency (TF-IDF) component), a localization component 501 (e.g., sliding window component, segmenter, and/or the like), a deep learning model component 401, and a similarity determination component 601 (e.g., cosine similarity component or scorer).

The filtering component 110 may be used to filter content (e.g., an interaction transcription) for specific utterances (e.g., terms) by an agent or customer. In some embodiments, the relevance determination component 301 can process sample phrases 204 that are associated with correct responses to one or more questions. The sample phrases 204 may be used to generate one or more target words 208 (e.g., target phrases, terms, important words, a list of important words, and/or the like). The one or more target words 208 can be input into the localization component 501 and can be used to generate a list of windows 210. In some embodiments, the list of windows 210/sample phrases 204 can be input into a deep learning model component 401 which can be used to generate embedding outputs 112 (e.g., embedding vectors), as discussed in more detail herein. As depicted, the embedding outputs 112 can be input into a similarity determination component 601 and used to generate similarity scores with respect to various sentences, windows, and/or phrases. The operations of the automated interaction processing system 101 may lead to generating response data 120 for a set of questions. In some embodiments, the automated interaction processing system 101 can process the entirety of the content 202 (e.g., interaction transcription). For example, the automated interaction processing system can generate embedding outputs for the entirety of the content 202 (e.g., interaction transcription) in order to generate response data 120.

The automated interaction processing system 101 can be implemented by a processor and memory (e.g., as a program stored on a computer readable medium). In some embodiments, the automated interaction processing system 101 can be a cloud service. Additionally, in some embodiments, the automated interaction processing system 101 can be implemented a local server or servers, or on an individual computer. Embodiments of the present disclosure can include or utilize a plurality of speech processing components.

In accordance with certain embodiments, one or more of the components of FIG. 1 may be implemented using cloud services to process content (e.g., interaction transcriptions) and perform other processes described above. For example, the components shown in FIG. 1 may be in the same or different cloud service environments and may communicate with each other over one or more network connections, such as, a LAN, WAN, Internet or other network connectivity. It should be understood that embodiments of the present disclosure using cloud services can use any number of cloud-based components or non-cloud-based components to perform the processes described herein.

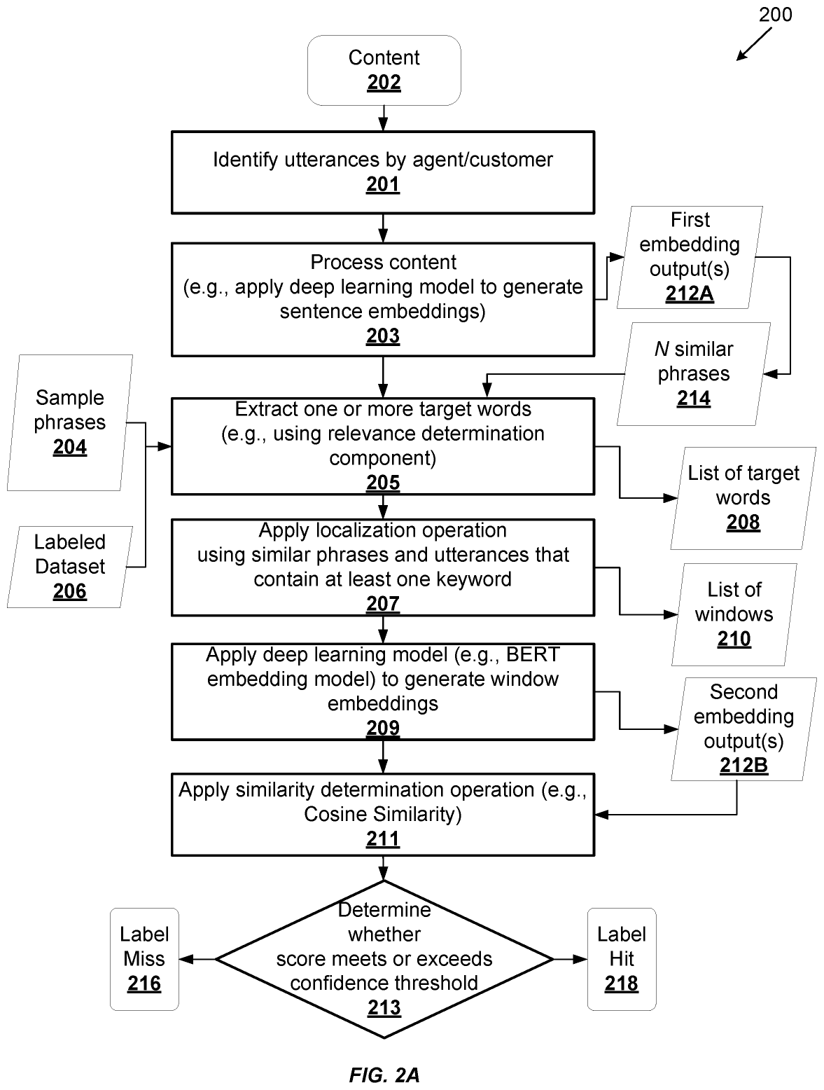

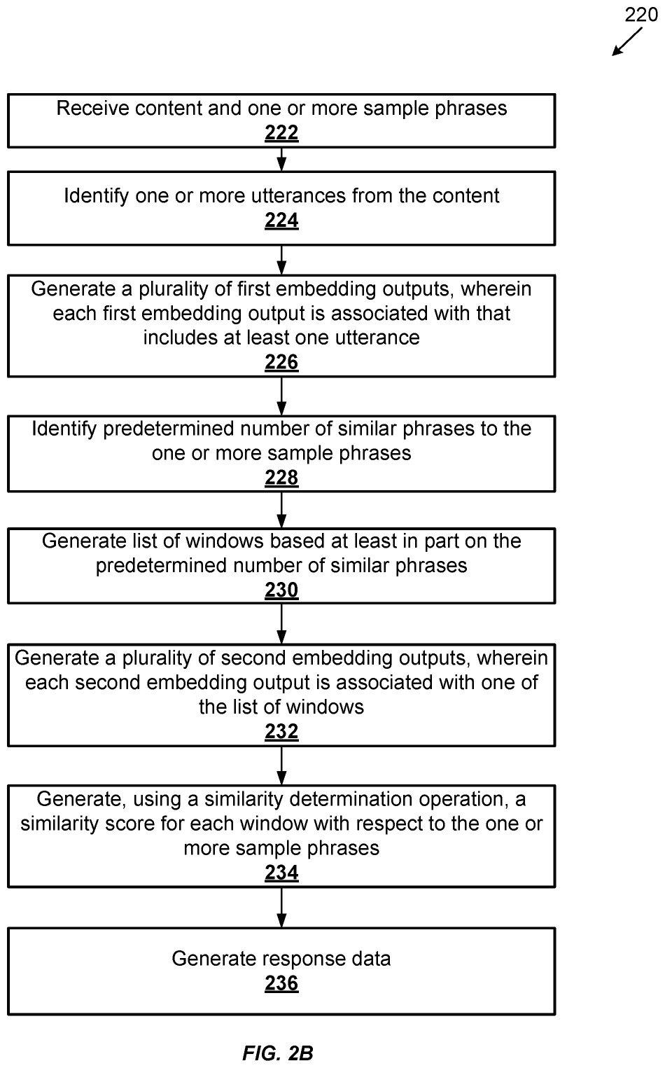

FIG. 2A illustrates an example flow diagram 200 of operations performed by an automated interaction processing system according to certain embodiments (such as, but not limited to automated interaction processing system 101 discussed above in connection with FIG. 1).

At block 201, the automated interaction processing system receives and processes content 202 (e.g., an interaction transcription). For example, the automated interaction processing system identifies (e.g., filters) at least a portion of the content 202 (e.g., interaction transcription) in order to identify specific utterances by an agent and/or a customer during an interaction event that can be used as an input to at least one other component, model, or sub-model of the automated interaction processing system (e.g., deep learning model component 401 or localization component 501).

At block 203, the automated interaction processing system can apply a deep leaning model to at least a portion of the content 202 (e.g., interaction transcription) and output a first embedding output 212A for each portion (e.g., phrase, sentence, or the like) of the content 202 (e.g., interaction transcription). The deep learning model can be or comprise a Transformer-based embedding neural network, such as, but not limited to, a Bidirectional Encoder Representations from Transformers (BERT) model, a pre-trained Bidirectional Encoder, a word embedding model, natural language processing model, convolutional neural network model, a Reformer model, a Unified Language Model, a Robustly Optimised BERT (RoBERTa) model, a generalized autoregressive model (e.g., XLNet model), or any other language-based model. The deep learning model (e.g., BERT embedding model) may be configured to process (e.g., vectorize or embed) at least a portion of the content 202 (e.g., phrases or sentences) and generate a numerical representation for each portion of the content 202 (e.g., phrase or sentence) in a multi-dimensional (e.g., an N-dimensional) embedding space. In various examples, an output of the deep learning model may be an embedding output that can be used as an input to at least one other component, model, or sub-model of the automated interaction processing system (e.g., similarity determination component). A BERT model can be configured to process any given word in relation to all other words in a sentence to vectorize or ‘embed’ a word or group of words (e.g., phrase, sentence, paragraph, etc.), according to certain embodiments. As further depicted in FIG. 2, based at least in part on the first embedding output(s) 212A, the automated interaction processing system can identify a predetermined number of similar phrases 214 to a sample or target phrase (e.g., sentences).

At block 205, the automated interaction processing system extracts one or more target words (e.g., keywords) from at least a portion of the content 202 (e.g., interaction transcription), for example, based at least in part on the predetermined number of similar phrases 214. For example, the relevance determination component 301 in the automated interaction processing system 101 can use a relevance determination component or model, such as a TF-IDF model to apply a TF-IDF operation to the sample phrases 204 and/or a labeled dataset 206. The relevance determination model may be a model that is configured to generate numerical representations indicating how important one or more words are in a group of words, document or corpus. For example, the automated interaction processing system can output one or more target words 208 (e.g., important or relevant words) from the sample phrases 204 and/or the labeled dataset 206. By way of example, the automated interaction processing system can process the sentence “how can I help you” and determine that “help” is a target word based on the one or more keywords extracted from a predetermined number of similar sentences to a sample or target phrase (e.g., sentence). In some examples, the automated interaction processing system is configured to identify phrases or sentences containing possible answers to questions in a content item (e.g., an incoming call or interaction transcription).

By way of example, an evaluation question (e.g., from an evaluation form) may be “Did the agent confirm the customer's address.” In this example, the sample phrases may comprise: (1) What is your address? (2) Would you please confirm your address? (3) Where do you live? The labeled dataset 206 may comprise a list of manually tagged “correct” sentences or phrases that may be uttered by an agent or customer representative in response to a given target sentence or phrase (e.g., a question or request). In some embodiments, the labeled dataset 206 further comprises associated scores for each possible sentence or phrase. The labeled dataset 206 can be used as ground truth data based on which the automated interaction processing system can generate response data. Additionally, the labeled dataset 206 can be used to determine the accuracy of outputs (e.g., response data) that are being generated by the automated interaction processing system to determine whether enough examples have been provided and/or whether the sentences being generated by the automated interaction processing system are improving the outputs. For example, an algorithm may be run on a user provided labeled dataset 206 to determine whether the algorithm is accurate with respect to the labeled dataset 206 in order to measure performance. In other words, the automated interaction processing system can use existing evaluations as test data. For example, the system can generate a score representing algorithm accuracy with respect to sample phrases 204 (e.g., manually tagged sentences) in order to identify whether additional, fewer, or different sentences need to be tagged. In some examples, since the data is highly imbalanced, and there may be tagging errors in the sample phrases 204 (e.g., manually tagged sentences), a macro recall metric can be used to evaluate the model. The macro recall can be expressed by the following ratio:

tp/(tp+fn) (1)

In Equation 1, tp is the number of true positives, and fn is the number of false negatives. The macro-recall calculates metrics for each label and finds their unweighted mean without taking label imbalance into account.

At block 207, the localization component 501 of the automated interaction processing system 101 applies a localization operation such as a sliding window operation (e.g., to at least a portion of the content 202 (e.g., interaction transcription) using the predetermined number of similar phrases 214 and utterances that contain at least one identified target word or keyword and outputs a list of windows 210. In some examples, target phrases or words may be a small portion of an overall utterance. For example, in the sentence “I am calling because I need assistance in order to pay my bill,” the phrase “bill” is an example of an target word. Accordingly, an automated interaction processing system component, model, or sub-model that utilizes target phrases and/or words to generate predictive outputs (e.g., similarity scores) will be more accurate than systems that may use larger portions of an interaction transcription or content (e.g., an entire utterance or document). By way of example, a similarity determination component that processes target phrases or words will more accurately and quickly identify similar entities (e.g., phrases or sentences) than a similarity scoring component that processes larger utterances or documents. In some embodiments, the automated interaction processing system can parse an overall utterance into smaller windows, and then within each window, determine similarity to a target phrase. The automated interaction processing system can filter through the content 202 (e.g., interaction transcription) using the sliding window operation.

At block 209, the deep learning model component 401 of the automated interaction processing system 101 applies a deep learning model or Transformer-based embedding neural network, such as, but not limited to, the pre-trained BERT model or other language-based model to a subset of the content 202. For example, the automated interaction processing system processes the list of windows 210 using the deep learning model and outputs a second embedding output 212B for each window. If the automated interaction processing system determines that “help” is an target word, then the system may identify each window from the transcription interaction or content 202 that contains the word “help” and then process each window using the deep learning model. The deep learning model may be configured to process (e.g., vectorize) the subset of the content 202 (e.g., list of windows 210) and generate a numerical representation for each window from the list of windows 210 in a multi-dimensional (e.g., an N-dimensional) embedding space. An output of an example BERT model can be a hidden state vector of a pre-defined hidden size corresponding to each token (e.g., an occurring word) in an input sequence (e.g., phrase, sentence, or window).

At block 211, the similarity determination component 601 of the automated interaction processing system 101 applies a similarity determination operation (e.g., cosine similarity operation, Euclidean distance operation, Jaccard similarity operation, Minkowski distance operation, and/or the like) to the output of the deep leaning model (e.g., the second embedding output for each window generated using the deep learning model or BERT embedding model). In some embodiments, windows, phrases or sentences with similar semantic meanings may be associated with high similarity scores (e.g., cosine similarity scores). In various embodiments, several possible answers to a question can be manually tagged and the automated interaction processing system can identify sentences that yield high cosine similarity in the interaction transcription or content. The automated interaction processing system can be configured to identify a predetermined number of sentences that are most similar to a target sentence or phrase (e.g., an embedding output or vector such as a numerical representation of at least a portion of content 202).

At block 213, the automated interaction processing system determines whether each output (e.g., score) generated using the similarity scoring operation meets or exceeds a confidence threshold, such as by meeting or exceeding a predetermined value. An example range of similarity values or scores may be between 0 and 1 or 0% and 100%. For example, if the confidence threshold is 75% or 0.75 and the determined confidence value is 70% or 0.7, then the confidence value does not meet or exceed the threshold. In another example, if the confidence threshold is 75% or 0.75 and the determined confidence value is 80% or 0.8, then the confidence value meets or exceeds the confidence threshold. In some embodiments, the confidence threshold may be a range of values (e.g., between 70% and 100% or between 0.7 and 1). In an instance in which the confidence value does not meet or exceed the confidence threshold, the automated interaction processing system labels the sentence a miss 216. Conversely, in an instance in which the confidence value meets or exceeds the confidence threshold, the automated interaction scoring system labels the sentence a hit 218. In some embodiments, each sentence that has a high similarity score with respect to a target phrase can be added to a list of phrases (e.g., sample phrases 204). By way of example, a target phrase may be “Please confirm your address” and an example confidence threshold may be 75%. If a first sentence from an interaction transcription or content is “Where do you live,” an example similarity score for the target sentence and the first sentence may be 76%. In another example, a second sentence from the interaction transcription or content may be “I want to confirm my account details,” and an example similarity score for the target sentence and the second sentence may be 35%. Accordingly, the automated interaction processing system may label the first sentence a hit 218 and label the second sentence a miss 216. Additionally, the automated interaction processing system may add the first sentence to the sample phrases 204 and may further associate the first sentence with an evaluation question and/or target phrase.

FIG. 2B illustrates an example flow diagram 220 of operations performed by an automated interaction processing system according to certain embodiments (such as, but not limited to automated interaction processing system 101 discussed above in connection with FIG. 1).

At block 222, the automated interaction processing system receives content (e.g., an interaction transcription) and one or more sample phrases. As discussed herein, the one or more sample phrases may comprise answers that are deemed correct in response to one or more evaluation questions.

At block 224, the automated interaction processing system identifies one or more utterances from the content. The one or more utterances may include words or terms that are identical or similar to the one or more sample phrases.

At block 226, the automated interaction processing system generates a plurality of first embedding outputs, wherein each first embedding output is associated with a phrase that includes at least one of the utterances. As discussed herein, the automated interaction processing system can apply a deep leaning model (e.g., BERT model) to generate a first embedding output for portions (e.g., phrases, sentences) that include at least one of the utterances.

At block 228, the automated interaction processing system identifies a predetermined number of similar phrases to the one or more sample phrases based at least in part on the first embedding outputs.

At block 230, the automated interaction processing system generates a list of windows based at least in part on the predetermined number of similar phrases. The list of windows may include or consist of the predetermined number of similar phrases to the one or more sample phrases identified at block 228.

At block 232, the automated interaction processing system generates a plurality of second embedding outputs, wherein each second embedding output is associated with one of the list of windows.

At block 234, the automated interaction processing system generates, using a similarity determination operation, a similarity score for each window with respect to the one or more sample phrases.

At block 236, the automated interaction processing system generates response data based at least in part on the similarity scores. As discussed herein, the response data may be comprise automatically generated answers to one or more questions from an evaluation form question set. For example, if an evaluation question is “Did the agent offer the customer a promotion?”, response data associated with the evaluation question may comprise an indication of whether or not the agent offered the customer a promotion (e.g., “yes” or “no”).

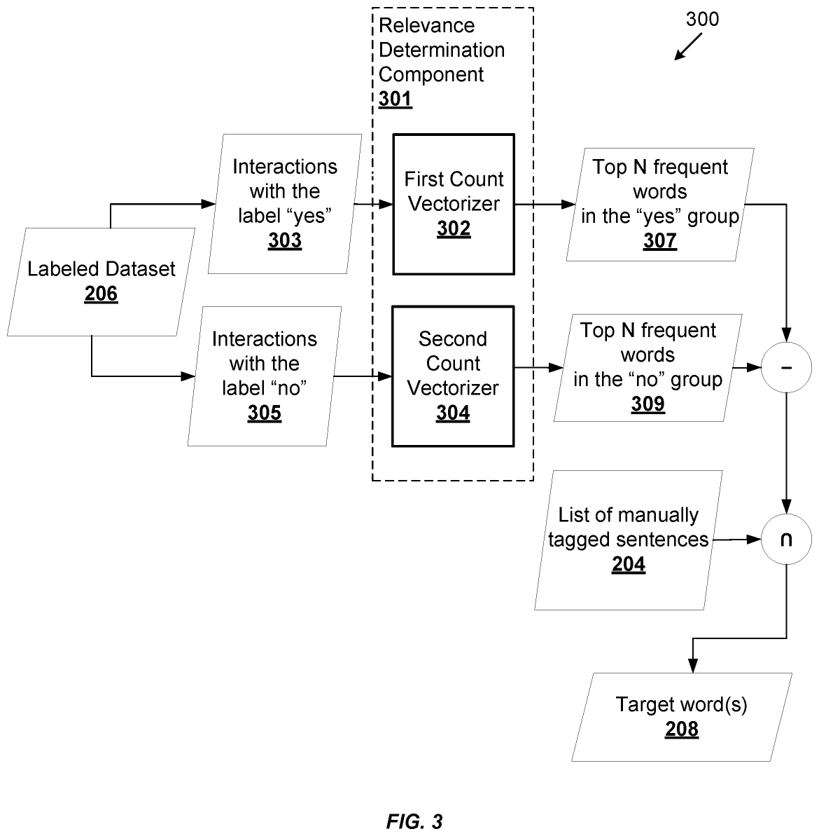

Referring now to FIG. 3, an operational example 300 depicting the relevance determination component 301 (such as, but not limited to, the relevance determination component 301 discussed above in connection with FIG. 1) according to certain embodiments is provided.

As depicted in FIG. 3, the relevance determination component 301 comprises a first count vectorizer 302 and a second count vectorizer 304 that are configured to extract one or more target words or keywords. In various examples, each of the first count vectorizer 302 and the second count vectorizer 304 are configured to tokenize textual data (e.g., at least a portion of the content 202). For example, a labeled dataset 206 can comprise interactions with the label “yes” 303 and interactions with the label “no” 305. The interactions with the label “yes” 303 may correspond with a correct answer to one or more evaluation questions, and the interactions with the label “no” 305 may correspond with incorrect answers to one or more evaluation questions. By way of example, a labeled dataset 206 may comprise a plurality of labeled interactions (e.g., thousands of manually labeled interactions) where each label (e.g., “yes” or “no”) indicates whether or not a given interaction answers one or more evaluation questions.

As depicted in FIG. 3, the relevance determination component 301 can process the interactions with the label “yes” using the first count vectorizer 302 and process the interactions with the label “no” using the second count vectorizer. As further depicted, an output of the first count vectorizer 302 can be a top N frequent word in the “yes” group 307, and an output of the second count vectorizer 304 can be a top N frequent words in the “no” group 309. The top N frequent words in the “no” group 309. Subsequently, the automated interaction processing system can compare the top N frequent word in the “yes” group 307 (e.g., from interactions that are labeled “yes” in response to one or more evaluation questions) and the top N frequent words in the “no” group 309 (e.g., from interactions that are labeled “no” in response to one or more evaluation questions). Then, the automated interaction processing system can combine the output of the relevance determination component 301 with the sample phrases 204 and output one or more target words 208.

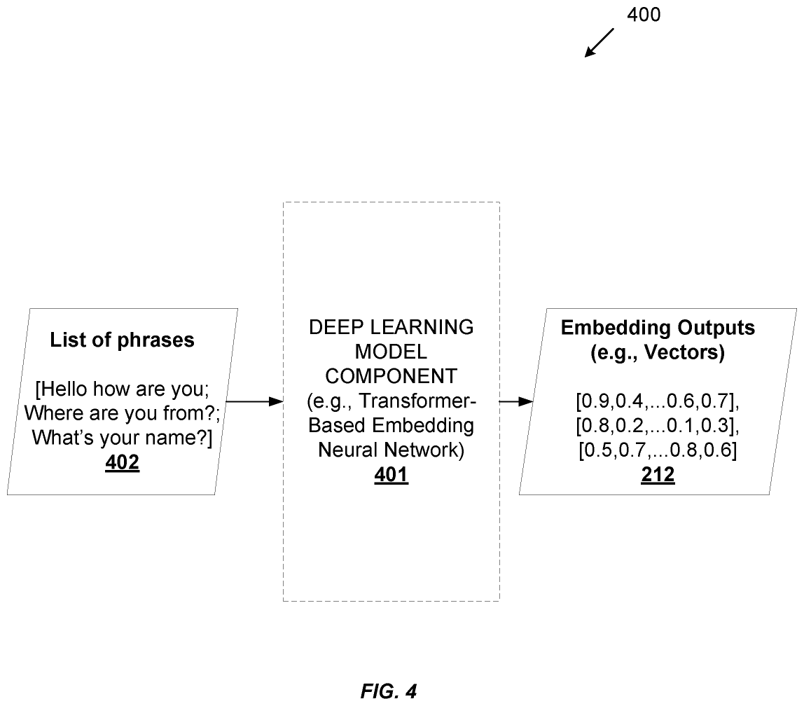

Referring now to FIG. 4, an operational example 400 depicting a deep learning model component 401 (such as, but not limited to, the deep learning model component 401 discussed above in connection with FIG. 1) according to certain embodiments is provided.

As discussed herein, the deep learning model component 401 may be or comprise a Transformer-based embedding neural network, a pre-trained BERT model, or other language-based model.

As depicted in FIG. 4, the deep learning model component 401 is configured to process a list of phrases 402 and generate a numerical representation of each sentence in a multi-dimensional (e.g., an N-dimensional) embedding space. In some embodiments, an output of the deep learning model is a hidden state vector of a pre-defined hidden size corresponding to each token (e.g., an occurring word) in an input sequence (e.g., sentence). In the example shown in FIG. 4, the deep learning model component 401 process the sentences “Hello how are you,” “Where are you from” and “What's your name” and generates an embedding output 412 (e.g., numerical representation or vector) for each phrase or sentence (e.g., as shown [0.9, 0.4, . . . 0.6, 0.7], [0.8, 0.2, . . . 0.1, 0.3], and [0.5, 0.7, . . . 0.8, 0.6], respectively). In some embodiments, sentences that are repeated frequently may be saved in cache rather than being re-embedded by the deep learning model component 401 thereby conserving computational resources and improving the overall processing speed of the automated interaction processing system.

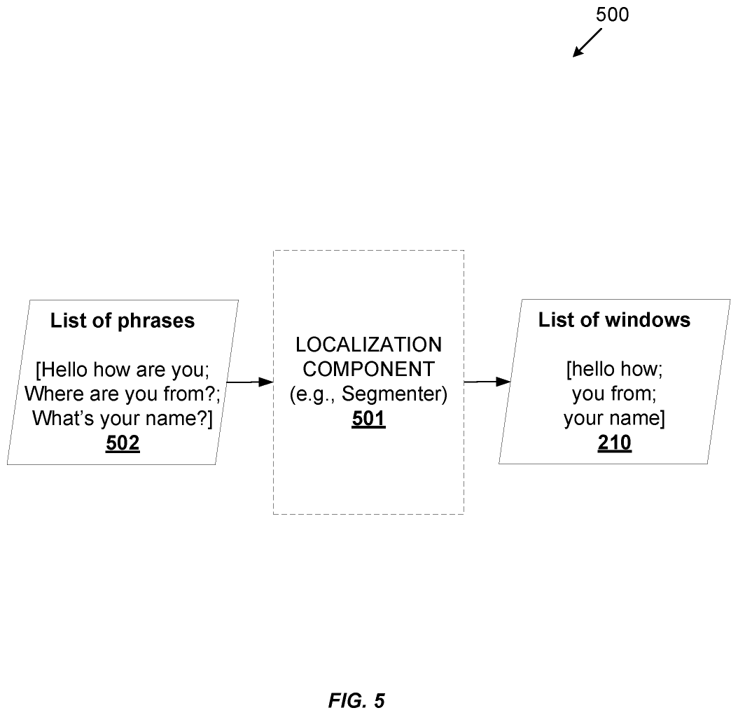

Referring now to FIG. 5, an operational example 500 depicting a localization component 501 (e.g., segmenter), such as, but not limited to, the localization component 501 discussed above in connection with FIG. 1 according to certain embodiments is provided.

In various examples, the localization component 501 (e.g., sliding window component, segmenter) is configured to process at least a portion of content 202/a list of phrases 502, for example, using a segmenter or applying a sliding window operation, and output a list of windows 210. In particular, the localization component 501 can identify target phrases or words that may be a portion of an overall utterance. In various examples, the automated interaction processing system can filter through or process at least a portion of the content 202 using the localization component 501.

As depicted in FIG. 5, the localization component 501 may process the sentences “Hello how are you,” “Where are you from?” and “What's your name” and output the windows (e.g., phrases) “Hello how,” “you from,” and “your name,” respectively.

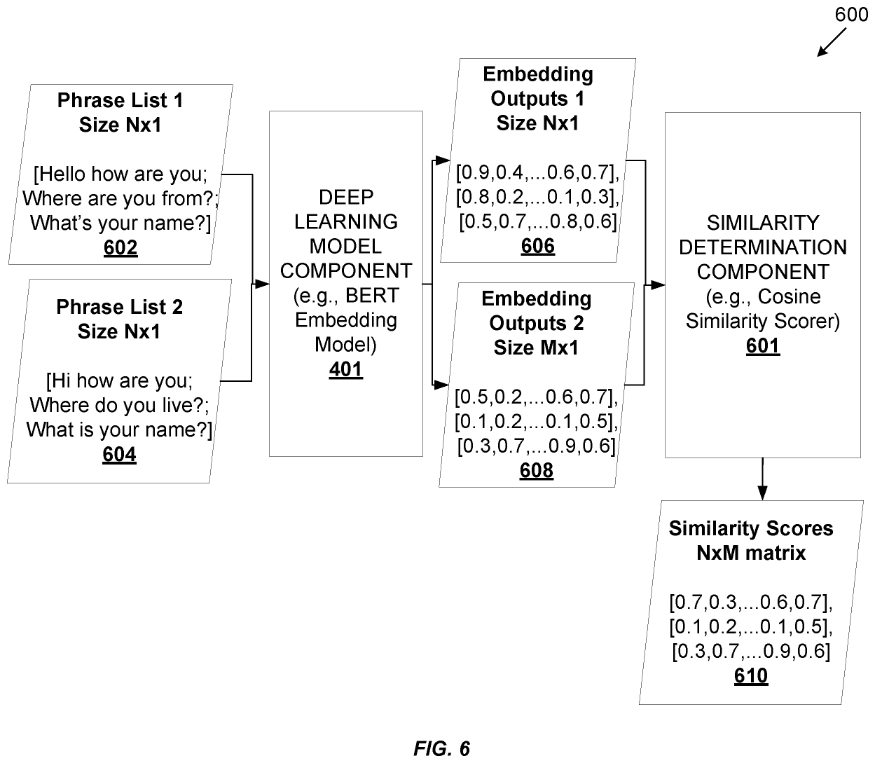

Referring now to FIG. 6, an operational example 600 depicting a deep learning model component 401 (such as, but not limited to, the deep learning model component 401 discussed above in connection with FIG. 1) and a similarity determination component 601 (e.g., cosine similarity scorer) according to certain embodiments is provided.

As discussed herein, the deep learning model component 401 may be or comprise a Transformer-based embedding neural network, a pre-trained BERT model, or any other language-based model. The similarity determination component 601 may be a cosine similarity scorer or model that is configured to generate a score describing a degree of similarity between two data entities (e.g., between two sentences).

As depicted in FIG. 6, the deep learning model component 401 is configured to process a first phrase list 602 (e.g., a sentence list) comprising an N×1 dimensional matrix and a second phrase list 604 comprising another N×1 dimensional matrix and generate numerical representations for each sentence in a multi-dimensional (e.g., an N-dimensional) embedding space. As shown, the deep learning model component 401 processes the first phrase list 602 and outputs corresponding N×1 dimensional first embedding outputs 606. Additionally, the deep learning model component 401 processes the second phrase list 604 and outputs corresponding M×1 dimensional second embedding outputs 608. In various embodiments, as depicted, the first embedding outputs 606 and the second embedding outputs 608 are used as input to the similarity determination component 601 (e.g., cosine similarity scorer). For example, as depicted, the similarity determination component 601 processes the first embedding outputs 606 and the second embedding outputs 608 and outputs similarity scores 610 comprising an N×M dimensional matrix. The similarity scores 610 may comprise values describing a measure of similarity between phrases from the first phrase list 602 and the second phrase list 604. The automated interaction processing system can determine whether each score generated by the similarity determination component meets or exceeds a confidence threshold, such as by meeting or exceeding a predetermined value. By way of example, for a first sentence “Hello how are you” and a second sentence “Hi how are you,” a similarity score may be 0.7. For a third sentence “where do you live” and a fourth sentence “I want to pay my bill” a similarity score may be 0.2. In the above example, if the confidence threshold is 0.6, then the automated interaction processing system determines that the first sentence and the second sentence are similar (e.g., have a similarity score that meets or exceeds the confidence threshold) and that the third sentence and the fourth sentence are not similar (e.g., have a similarity score that does not meet or exceed the confidence threshold). In some embodiments, the similarity determination component 601 is configured to identify a predetermined number of similar sentences to a target sentence or phrase. The outputs of the similarity determination component 601 can be used to generate response data with respect to at least a portion of content 202 (e.g., interaction transcriptions). In some embodiments, the automated interaction processing system may add phrases that are determined to be similar to a target phrase to a database comprising stored phrases.

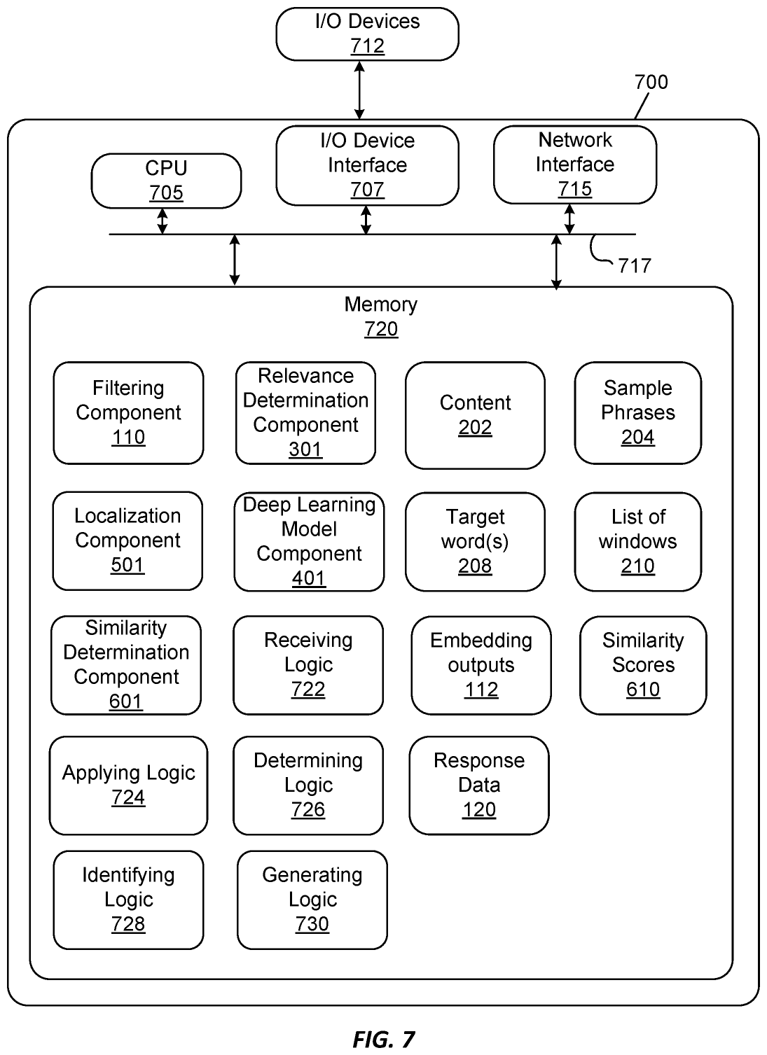

FIG. 7 illustrates an example of a computing system 700 that may include the kinds of software programs, data stores, and hardware according to certain embodiments. As shown, the computing system 700 includes, without limitation, a central processing unit (CPU) 705, a network interface 715, a memory 720, and storage 730, each connected to a bus 717. The computing system 700 may also include an I/O device interface 707 connecting I/O devices 712 (e.g., keyboard, display, and mouse devices) to the computing system 700. The I/O device interface may further comprise, for example, a data bus with an accompanying control/address bus. Further, the computing elements shown in computing system 700 may correspond to a physical computing system (e.g., a system in a data center) or may be a virtual computing instance executing within a computing cloud.

The CPU 705 retrieves and executes programming instructions stored in memory 720. The memory 720 can include a database for storing data/information, including software components that are executable by a processor. The bus 717 is used to transmit programming instructions and application data between the CPU 705, I/O device interface 707, network interface 715, and memory 720. Note, CPU 705 is included to be representative of a single CPU, multiple CPUs, a single CPU having multiple processing cores, and the like, and the memory 720 is generally included to be representative of random-access memory. The memory 720 may be a disk drive or flash storage device. Although shown as a single unit, the memory 720 may be a combination of fixed and/or removable storage devices, such as fixed disc drives, removable memory cards, optical storage, network-attached storage (NAS), or a storage area network (SAN).

Illustratively, the memory 720 includes filtering component 110, relevance determination component 301, localization component 501, deep learning model component 401, and similarity determination component 601 that perform the operations described herein. The memory 720 further includes hardware and software implementing receiving logic 722, applying logic 724, determining logic 726, identifying logic 728, and generating logic 730.

Further, the memory 720 includes content 202 (e.g., interaction transcriptions or other forms of textual data), sample phrases 204, one or more target words 208, a list of windows 210, embedding outputs 112, similarity scores 610, and response data 120, all of which are also discussed in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed systems, or in a virtual equivalent, such as, a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Thus, the automated interaction processing system 101 and implementations therein described in the present disclosure facilitate fast and accurate automated evaluation of interaction events between consumers and customer service representatives without intensive manual effort or human intervention.

What is claimed is:

1. A computer-implemented method comprising:
receiving content and one or more sample phrases, wherein the content comprises a plurality of phrases;
identifying one or more utterances from the content;
generating a plurality of first embedding outputs, wherein each first embedding output is associated with a phrase that includes at least one of the utterances;
identifying a predetermined number of similar phrases to the one or more sample phrases based at least in part on the first embedding outputs;
generating a list of windows based at least in part on the predetermined number of similar phrases;
generating a plurality of second embedding outputs, wherein each second embedding output is associated with one of the list of windows;
generating, using a similarity determination operation, a similarity score for each window with respect to the one or more sample phrases; and
generating response data based at least in part on the similarity scores.

2. The computer-implemented method of claim 1, further comprising:
Identifying, using a relevance determination operation, one or more relevant words from the predetermined number of similar phrases, wherein the list of windows is generated based at least in part on the predetermined number of similar phrases and phrases that contain one or more of the relevant words.

3. The computer-implemented method of claim 1, wherein the list of windows is generated using a localization operation.

4. The computer-implemented method of claim 1, further comprising:
labeling each phrase with a similarity score that meets or exceeds a confidence threshold as similar.

5. The computer-implemented method of claim 4, further comprising:
adding similar phrases to a labeled dataset or database of stored sentences.

6. The computer-implemented method of claim 1, further comprising:
labeling each phrase with a similarity score that does not meet or exceed a confidence threshold as dissimilar.

7. The computer-implemented method of claim 1, wherein identifying the one or more relevant words comprises applying a relevance determination operation or a term frequency-inverse document frequency operation.

8. The computer-implemented method of claim 1, wherein generating at least one of the first embedding outputs and the second embedding outputs comprises applying at least one of a deep learning model, neural network, a transformer-based model, and a pre-trained Bidirectional Encoder Representations from Transformers (BERT) model.

9. A computer system comprising:
a processor; and
a memory operably coupled to the processor, the memory having computer-executable instructions stored thereon that, when executed by the processor, causes the computer system to:
receive content and one or more sample phrases, wherein the content comprises a plurality of phrases;
identify one or more utterances from the content;
generate a plurality of first embedding outputs, wherein each embedding output is associated with a phrase that includes at least one of the utterances;
identify a predetermined number of similar phrases to the sample phrases based at least in part on the first embedding outputs;
generate a list of windows based at least in part on the predetermined number of similar phrases;
generate a plurality of second embedding outputs, wherein each second embedding output is associated with one of the list of windows;
generate, using a similarity determination operation, a similarity score for each window with respect to the one or more sample phrases; and
generate response data based at least in part on the similarity scores.

10. The computer system of claim 9, wherein the computer-executable instructions further include instructions to cause the processor to:
Identify, using a relevance determination operation, one or more relevant words from the predetermined number of similar phrases, wherein the list of windows is generated based at least in part on the predetermined number of similar phrases and phrases that contain one or more of the relevant words.

11. The computer system of claim 9, wherein the computer-executable instructions further include instructions to cause the processor to:
generate the list of windows using a localization operation or sliding window operation.

12. The computer system of claim 11, wherein the computer-executable instructions further include instructions to cause the processor to:
label each phrase with a similarity score that meets or exceeds a confidence threshold as similar.

13. The computer system of claim 9, wherein the computer-executable instructions further include instructions to cause the processor to:
add similar phrases to a labeled dataset or database of stored sentences.

14. The computer system of claim 9, wherein the computer-executable instructions further include instructions to cause the processor to:
label each phrase with a similarity score that does not meet or exceed a confidence threshold as dissimilar.

15. The computer system of claim 9, wherein the computer-executable instructions further include instructions to cause the processor to:
identify the one or more relevant words by applying a relevance determination operation or a term frequency-inverse document frequency operation.

16. A non-transitory computer readable medium comprising instructions that, when executed by a processor of a processing system, cause the processing system to perform a method, comprising instructions to:
receive content and one or more sample phrases, wherein the content comprises a plurality of phrases;
identify one or more utterances from the content;
generate a plurality of first embedding outputs, wherein each embedding output is associated with a phrase that includes at least one of the utterances;
identify a predetermined number of similar phrases to the sample phrases based at least in part on the first embedding outputs;
generate a list of windows based at least in part on the predetermined number of similar phrases;
generate a plurality of second embedding outputs, wherein each second embedding output is associated with one of the list of windows;
generate, using a similarity determination operation, a similarity score for each window with respect to the one or more sample phrases; and
generate response data based at least in part on the similarity scores.

17. The non-transitory computer readable medium of claim 16, wherein the instructions further include instructions to cause the processor to:
identify, using a relevance determination operation, one or more relevant words from the predetermined number of similar phrases, wherein the list of windows is generated based at least in part on the predetermined number of similar phrases and phrases that contain one or more of the relevant words.

18. The non-transitory computer readable medium of claim 16, wherein the instructions further include instructions to cause the processor to:
generate the list of windows using a localization operation or sliding window operation.

19. The non-transitory computer readable medium of claim 16, wherein the instructions further include instructions to cause the processor to:
label each phrase with a similarity score that meets or exceeds a confidence threshold as similar.

20. The non-transitory computer readable medium of claim 16, wherein the instructions further include instructions to cause the processor to:
add similar phrases to a labeled dataset or database of stored sentences.
